(19) United States
(12) Patent Application Publication
(10) Pub. No.: US 2006/0226201 A1
(43) Pub. Date: Oct. 12, 2006

(54) Circuit board carrier/solder pallet

(75) Inventor: Rich Reed, Strongsvill, OH (US)

Correspondence Address: PEARNE & GORDON LLP, 1801 EAST 9TH STREET, SUITE 1200, CLEVELAND, OH, 44114-3108, US

(73) Assignee: Electrolock, Inc.

(21) Appl. No.: 11/400,866

(22) Filed: Apr. 10, 2006

Related U.S. Application Data
(60) Provisional application No. 60/670,537, filed on Apr. 11, 2005.
(60) Provisional application No. 60/711,232, filed on Aug. 25, 2005.

(51) Int. Cl. A47J 36/02

(52) U.S. Cl. 228/101

(57) ABSTRACT

Provided is a plaque and its method of manufacture, the plaque including a cured thermoset phenolic resin and a reinforcing material that is molded into a controlled thickness. Also provided is a solder pallet utilizing the plaque in its manufacture. The plaque can be manufactured by forming a preform of the raw materials, preheating the preform, molding the preform into a plaque of the desired thickness, and then cooling the plaque at an elevated temperature to maintain the flatness of the plaque. The plaque can then be formed into the desired solder pallet by cutting the plaque to an appropriate size, if necessary, adding holes an clips for use in a soldering process for soldering circuit boards, for example.

### CROSS-REFERENCES TO RELATED APPLICATIONS

This application claims the benefit of provisional application No. 60/670,537 filed on Apr. 11, 2005, and provisional application No. 60/711,232, filed on Aug. 25, 2005, both incorporated herein by reference.

### BACKGROUND OF THE INVENTION

This application relates to a circuit board carrier and/or a solder pallet for use in a soldering machine, and to its method of manufacture.

A solder pallet having one or more improved properties, such as higher temperature performance (such as around 270 degrees C. Tg or above vs. current solutions of only about 170˜190 degrees C.), ease of machining, long-term. wear, and durability under a combination of high temperature exposure and aggressive chemicals would be useful. In addition, it would be useful to avoid glass exposure due to wear, which can be a problem with at least some current materials.

Furthermore, a plaque used for producing a solder pallet with the above properties would also be useful, especially if the plaque could be manufactured to meet thickness requirements of the solder pallet manufacturer or customer, and if the plaque, and thus the resulting solder pallet, could utilize a thermoset phenolic resin having one or more of the outstanding characteristic of cured thermoset phenolic molding materials.

### SUMMARY OF THE INVENTION

Provided are a plurality of embodiments the invention, including, but not limited to, a flat plaque for use in a soldering process, the plaque comprising: a thermoset phenolic resin; and a re-enforcing fiber distributed throughout the plaque, wherein the composition has been formed into the flat plaque at a desired thickness.

Further provided is a plaque for use in making a solder pallet, the plaque comprising: a thermoset phenolic resin; a glass re-enforcing fiber distributed throughout the plaque; and a conducting or semi-conducting material distributed throughout the plaque, wherein the plaque has a glass transition temperature of more than 170 degrees Celsius; and wherein the plaque is at least semi-conducting for discharging static electricity that may be present during use of the solder pallet.

Also provided is a solder pallet, such as described herein, using one of the above plaques or a plaque described elsewhere herein, with the pallet further comprising one or more clips for holding a circuit board to the pallet, and/or including one or more holes so that molten solder can access the circuit board or a component thereon.

Further provided is a method of manufacturing a plaque, such as one of those described herein, for use in a soldering process, the method comprising the steps of: providing a composition including a thermoset phenolic resin and a plurality of re-enforcing fibers; and forming the plaque in a mold by providing heat and pressure to the composition to form a solid plaque of a desired thickness.

Also provided is a method of manufacturing a plaque, such as one described herein, the plaque for use in a soldering process, the method comprising the steps of:
providing a precursor composition including the steps of:
providing a thermoset phenolic resin,
providing re-enforcing fibers, and
forming the resin and fibers into the precursor composition;
forming a preform by putting a portion of the precursor composition under pressure to form the preform;
pre-heating the preform;
molding the pre-heated preform in a mold by providing heat and pressure to the preform to form a molded plaque; and
maintaining a flatness of the plaque by cooling the molded plaque against smooth surfaces at an elevated temperature, thereby forming the plaque.

Still further provided is a method of manufacturing a solder pallet, such as one described herein, by one of the methods described above or elsewhere herein, with the method including the steps of providing one or more clips for holding a circuit board to the pallet, and/or providing one or more holes so that molten solder can access the circuit board or a component thereon.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 shows a drawing of the front side of one example embodiment of a solder pallet;

FIG. 2 shows a drawing of the front side of another example embodiment a solder pallet;

FIG. 3 shows a drawing of the back side of the example embodiment of FIG. 1;

FIG. 4 shows a drawing of the back side of the example embodiment of FIG. 2;

FIG. 5 shows the front side of still another example embodiment of a solder pallet that is holding a circuit board for undergoing a soldering process;

FIG. 6 shows the back side of the example embodiment of FIG. 5 shown holding the circuit board before undergoing a soldering process;

FIG. 7 shows a heating device for pre-heating example preforms for forming an example embodiment of a plaque used to create a soldering pallet;

FIG. 8 shows an example of a mold for forming an example plaque from one or more preforms, such as the example preforms shown in FIG. 7;

FIG. 9 shows an example of a flattening device for keeping a plaque flat during cooling at elevated temperatures after molding; and

FIG. 10 is a flow chart showing an example manufacturing process that can be used for manufacturing a precursor, then a plaque and then a soldering pallet, such as those described herein.

### DETAILED DESCRIPTION

Provided is a plaque for producing a solder pallet for use, for example, in soldering machines, such as for wave soldering, and a method of manufacturing the plaque. Also provided is a solder pallet produced from the plaque, and a precursor composition and a resulting preform used in manufacturing the plaque.

The outstanding characteristic of cured thermoset phenolic molding material can provide excellent thermal performance. Thermal performance refers to the ability of a molded plastic product to maintain its structural integrity, under mechanical load during a prolonged exposure to elevated temperatures. The thermal performance of polymer systems is closely related to their glass transition temperature (Tg). This is the temperature at which the molecules rapidly gain in their mobility as the cured molded sample is heated. Even in the presence of fillers and reinforcements that provide the apparent initial rigidity, exposure to temperatures above the Tg will usually cause a polymer to flow or creep under load. Thus, in at least some embodiments, a cured thermoset phenolic molding material is utilized to provide improved thermal performance.

The relatively high glass transition temperature of cross-linked polymers, such as phenolic resins, can result in excellent resistance to creep under mechanical load. A useful property of a cured phenolic material is the ability to raise its Tg by a carefully controlled post bake protocol, such as heating the part to 200 degrees C. and/or repressed in a device under pressure and temperature of 200 degrees C., after the part is molded. When correctly applied, the post bake program can result in a further improvement in creep resistance, dimensional stability, and modulus (stiffness) at elevated temperature. Thus, utilizing such cross-lined polymers can lead to a solder pallet that shows improved creep resistance.

Because of possible excellent thermal performance, phenolic molding materials are specified to insulate and protect sensitive components from the adverse effect of high temperature exposure. The solder pallet according to at least some embodiments can be formulated with resole or novolac resin systems, and specially selected fillers and reinforcements, in order to meet end use specifications. Consumer safety can be enhanced when the potential for the end product to overheat, melt or initiate a fire is minimized through the selective use of a heat resistant phenolic molding material.

Phenolic molding material can be formulated to provide tight dimensions with minimal deformation under mechanical load at elevated temperatures. This characteristic is useful when considering calibration requirements, screw-torque retention, and dimensional specifications to prevent thermal, mechanical, or electrical failure, especially during thermal cycling of end used products. Thus, this material can be usefully utilized in each of the precursor, the preform, the plaque, and the solder pallet, all described herein in more detail.

This unique phenolic molding material can also be enhanced with graphite, PTFE, and other internal lubricants. This formulation provides excellent lubricity and abrasion resistance for components that require repeated mechanical cycling or part-to-part contact, such as solder pallets. A key advantage of components molded from these materials is their ability to maintain surface smoothness after mechanical lapping. Thus, a plaque and a resulting solder pallet that uses such material can show similar benefits.

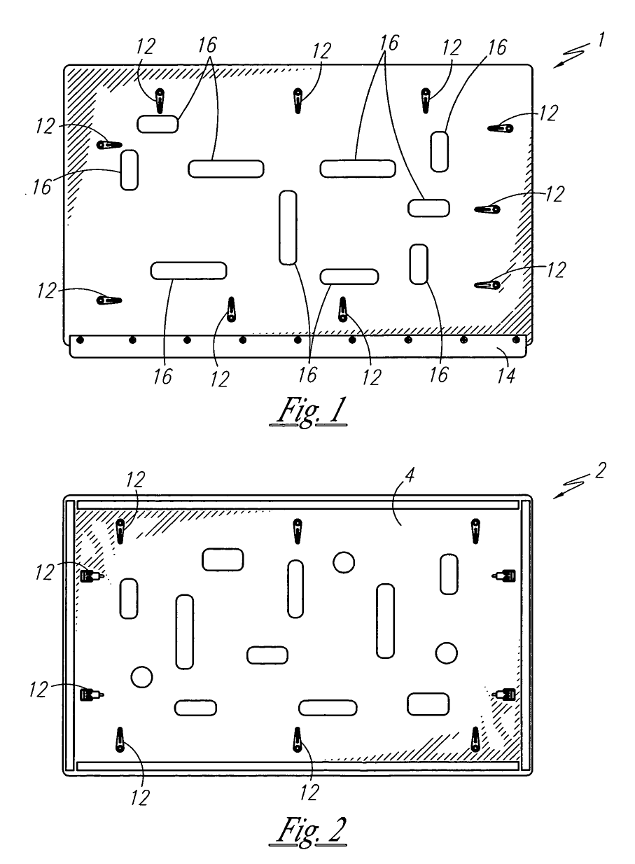

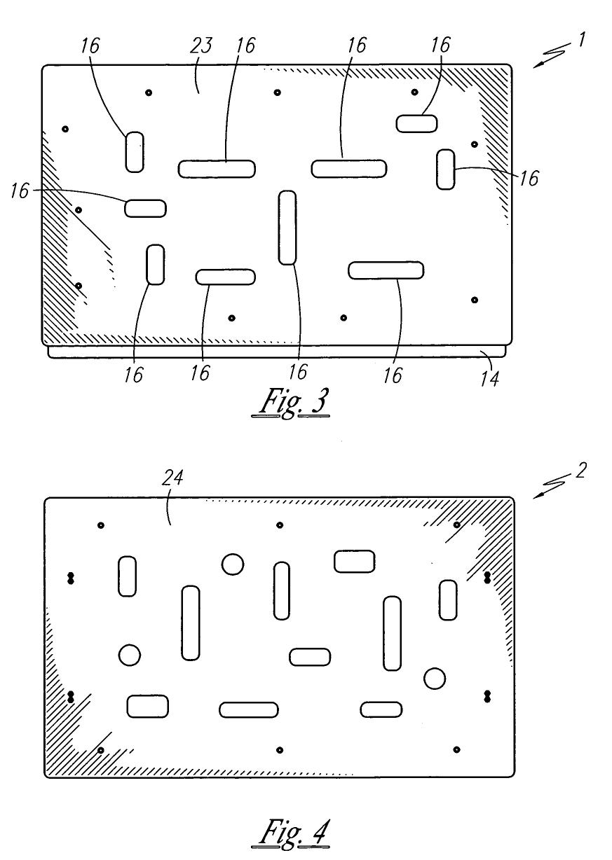

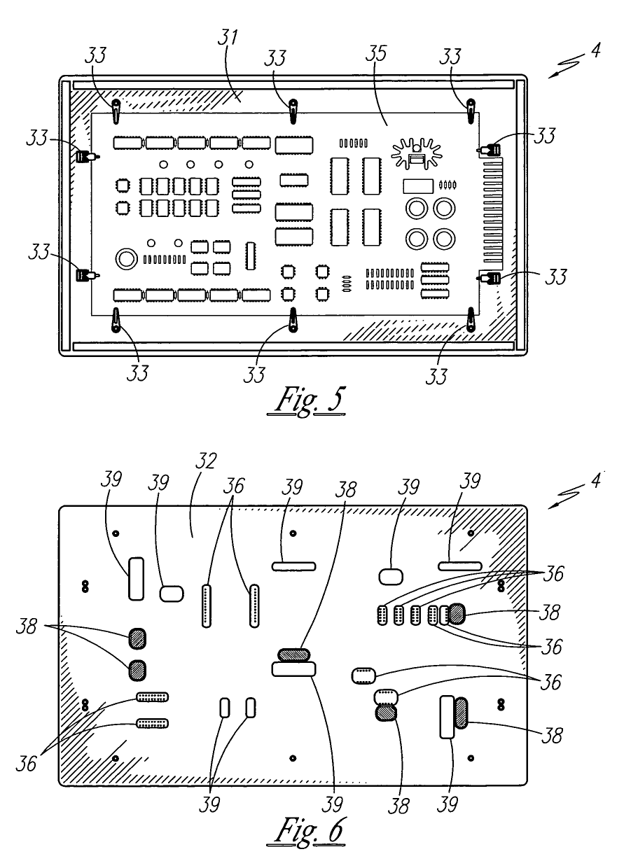

FIGS. 1 and 2 show front sides 3, 4 of example embodiments of solder pallets. These solder pallets 1, 2 use various types of clips 12 to be used for holding circuit boards in place. FIG. 1 shows a metal strip 14 for use as a stiffener to maintain dimensional stability under extreme temperature changes. The solder pallets 1, 2 have holes 16 (numbered only for the first embodiment for clarity), which will be discussed in more detail later. FIGS. 3 and 4 show back sides 5, 6 of the respective solder pallets 1, 2.

FIGS. 5 and 6 show the front side 31 and the back side 32 of still another example solder pallet 4, with a circuit board 25 mounted on the front side 31 using pins 33 to hold the board in place. Note that the holes 36 are provided for exposing the leads (pins) of various circuit board components (chips or other discrete components) through the holes 36 at the back of the pallet 4 to access a solder bath or stream for soldering the leads (pins) to appropriate circuit board etchings (not shown) on the circuit board 35. These boards can be used for wave soldering or other soldering processes, for example. Also shown are machined portions 38 that can be used for machine process flow and do not receive solder. These machined portions can be designed with a gradual radius to avoid 90 degree cuts for process ease. Additional holes 39 can be provided for additional components or etchings to access the solder during soldering, as desired.

### EXAMPLE RAW MATERIALS

The raw material used for at least some of the embodiments of the plaque and the resulting solder pallet include a polymer, such as a phenolic resin matrix, of which Novalac Phenol Formaldehyde is an example. The polymer material can be reinforced with a reinforcing material, such as a chopped strand fiberglass, for example, along with graphite, for example, and potentially with other “metallo-silicates” as optional materials, as desired.

Using the phenolic resin polymer described above in the manufacturing process can provide a raw material that is a “single-stage” phenolic molding compound that does not yield any ammonia smell when exposed to high temperatures, such as use in a soldering process, for example. Using the unique blend of phenolic resin polymer with the chopped glass, by adding graphite or some other conductor or semiconductor, can yield a product that is at least electrically semi-conductive, and thus that can be utilized to bleed off static discharge that may be present in the soldering process for which the plaque or solder pallet may be used. Such a polymer formulation as described herein can also yield a material with a glass transition temperature of about 270 degrees Celsius, and which can have the technical properties listed in the technical data sheet provided below.

### EXAMPLE MANUFACTURING PROCESS

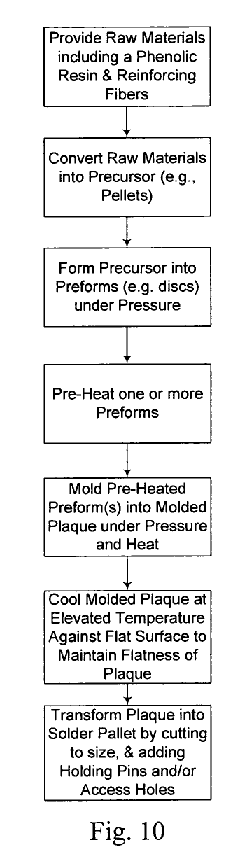

An example process that can be used as a manufacturing method to produce at least some embodiments of the plaques for forming solder pallets is now described, and one embodiment is shown in the flow chart of FIG. 10. This process can use a hybrid compression/injection molding process used for thermoset phenolic polymers. One example process is as follows:

The raw materials, including a phenolic resin that may be in powder or granular form, along with additional materials such as those described above (such as reinforcing fibers, etc.), are put into composition by mixing the materials together. The materials can be formed into a precursor composition designed for ease of transport and handling, for example, transformed into a pelletized or granular form. This precursor can be manufactured and provided by a third-party manufacturer, for example. Accordingly, the precursor typically includes the phenolic resin and one or more of: a reinforcing fiber such as fiberglass, a conducting or semiconducting material such as carbon (or other “metallo-silicates”), and a lubricant such as the carbon in the form of graphite, or PTFE. Additional materials could be included in the precursor for obtaining specific properties, such as special colors, etc. This precursor could be formed from the raw materials using pressure and/or heat, as needed.

The precursor can then be formed into a plurality of preforms by putting the pellets, or other precursor material, under pressure at room temperature to form the desired shape. For example, a cylinder can be formed that can be cut into a plurality of “puck-shaped” or rectangular prisms can be formed into “biscuit-shaped” preforms, or the preforms can be individually formed. Different shapes can also be formed, as desired, such as angular shapes, for example. Heat could be provided during forming the preforms, if desired, or they could be formed at room temperature, as described above. These preforms are thus derived from granular raw materials that are compressed into shape, in order to make it easier to handle and transfer the material from an Infrared preheating apparatus to an actual heated mold (described below). The preforms thus share the same composition as the precursors.

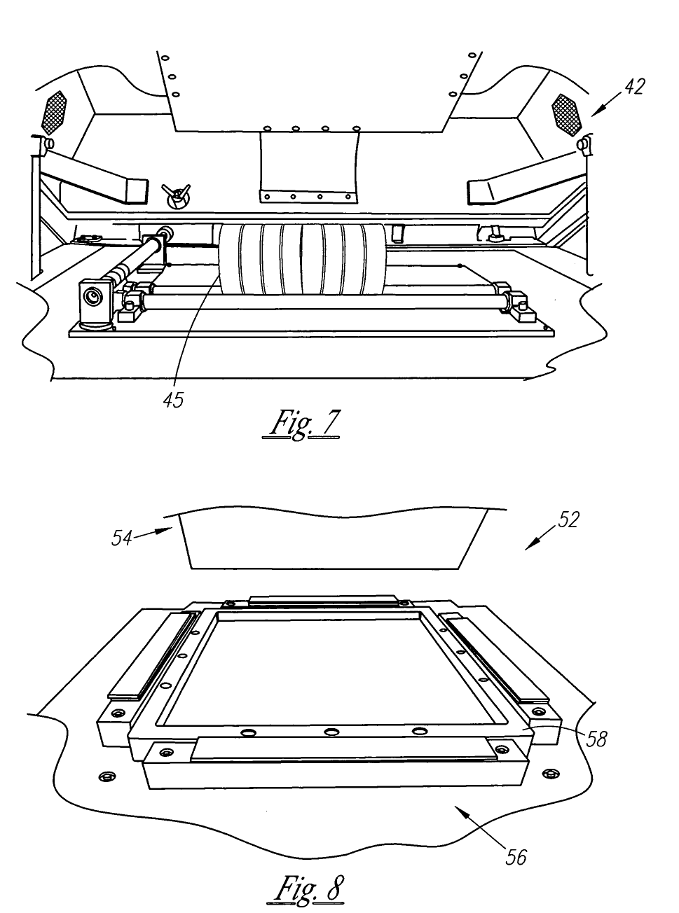

These preforms can then be pre-heated to aid in processing. FIG. 7 shows an infrared preheating device 42 with a plurality of disc-shaped preforms 45 being pre-heated using infrared heating, although other methods of pre-heating the preforms could also be utilized. The preform is heated for some time period, such as for a 30 second cycle, to reduce cycle time in the mold. Alternatively, the pre-heating step may be skipped, if desired, and all heating done during the molding process.

One or more of the pre-heated preforms (about 10 or so of the size shown in FIG. 7 for the mold shown herein) can then be placed in the mold 52, shown in FIG. 8. The mold is then closed with about 3000 pounds per square inch of pressure used to compress the material to the desired thickness, while also heating the mold at about 325-350° F. Alternative molding processes using different pressures and/or different temperatures could also be utilized, especially depending on the chosen raw materials.

The mold is opened, the top and bottom cores 54, 56 are moved apart, while the cavity wall 58, shaped like a picture frame, retracts downward, exposing the molded plaque sitting on the bottom core 56. This process can be used to mold the product into a plaque to a desired thickness and flatness specification, and eliminate the need for knock out pins and thus avoid any corresponding marks on the surface of the plaque.

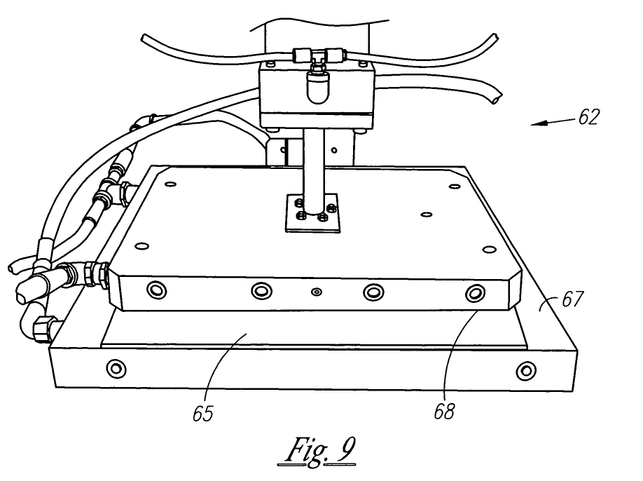

Next, the plaque can be quickly transferred to a temperature regulated flatness device 62, shown in FIG. 9 with a plaque 65 thereon, to control flatness and/or warp after the plaque is molded. The transfer could be done manually, for example, using protective gloves. The plaque is “cooled” on the flatness device against flat surfaces 66 and 67 at elevated temperatures (about 250 degrees F., for example) for some period of time, for example for about 5 minutes, to maintain flatness of the plaque. The plaque can then be removed from the device 62 to cool at room temperature, for example. This device 62 can provide some limited pressure to the cooling plaque, such as the pressure that comes from the dead load of a steel plate used as an upper flat surface 66, for example (at about 1 psi). Additional pressure could be provided if desired, or no pressure at all. The use of the flatness device ensures that the plaque remains substantially flat (avoiding warping), and thus helps to avoid any need to sand down the plaque to meet flatness and thickness requirements of customers. The device can also help keep the plaque surface at a desired smoothness.

Finally, solder pallets can be formed from the cooled plaque by machining (such as cutting) each plaque into a plurality of pieces to make solder pallets. The solder pallets might range in size roughly from 8″×10″ to 18″×24″, for example. The pallets are further formed by adding clips to the machined plaque pieces (such as by screwing or riveting them in place, for example) for mounting circuit boards thereon. The pins should probably be rotatable or otherwise movable to make mounting and dismounting the circuit boards easier. Furthermore, the plaque pieces can be further processed into the desired solder pallet configuration by machining holes in the plaque to match the pattern of the circuit boards mounted thereon, so that the molten solder of a solder bath or wave soldering machine can come into contact with the appropriate portion of the circuit board, for example. One or more stiffeners to maintain dimensional stability under extreme temperature changes can also be added. Machined portions that are for machine process flow and do not receive solder can also be added.

Various variations of this manufacturing process can also be used, such as leaving out the preform-forming steps and using the pellets directly, or leaving out the flattening/cooling step and letting the device cool in the mold, or elsewhere, for example. Additional variations are also possible, and within the scope of this disclosure.

A process with the materials described above can be used to form a plaque or solder pallet with the following properties:

Technical Data Sheet

| | | ASTM |
|---|---|---|
| Property | Value | Test Method |
| Color | Black | |
| ESD | 10\hat{ }5-10\hat{ }9 | D 4496 |
| Machinability | Excellent | |
| Chemical Resistance | Excellent | |
| Heat Deflection Temperature | ≧550° F. | D 648 |
| Water Absorption | .14 max | D 570 |
| Specific Gravity | 1.70 | D 792 |
| Flexural Strength, PSI | 25,000 | D 790 |
| Compressive Strength, PSI | 29,000 | D 695 |
| Warp | +/−.015″ | TIR over entire |
| | | sheet |
| Thickness Tolerance | +/−.005″ | Over the |
| | | entire sheet |
| Thickness, mm | e.g., 5, 6, 8, 10, 12 | |
| Sheet Size | 25″ × 25″ × various | |
| | thicknesses | |
| | (e.g., 3 mm to 12 mm | |

### EXAMPLE USES

As described herein, the raw materials are transformed, via a manufacturing process such as the example process described above, from granular or other discrete forms into the desired rigid solid plaque of the desired thickness, which can then be made into a solder pallet for use in a soldering process. As far as raw material production goes, the phenolic resin can be manufactured in a reactor (via a reaction of phenol & formaldehyde), and the chopped glass fiber (and/or other reinforcements which may include mineral fibers and cellulose) can then be added along with mineral fillers (if any), the graphite, titanium dioxide, and internal lubricants (such as zinc stearate and/or other stearate compounds, for example), to form the preform to aid in the molding process.

The solder pallet to be used for supporting the soldering process can be formed from the process described herein, or a similar process, and having the described, or similar construction.

Furthermore, the invention can provide a plaque with the disclosed composition and/or properties that can be sold to fabricators/designers which can then be used to form a solder pallet or circuit board carrier as desired by the fabricators/designers. The initial material will be molded in, for example, 25″×25″ square plaques by various thicknesses, as described above. The described plaque may also be utilized for other purposes, especially those where the desired properties, such as the glass transition temperature, are needed.

Fabricators can use a Computer Numeric Control (CNC) machine to modify the plaque to be used as a selective solder pallet and/or tooling used in “reflow” and surface mount technology. This forms the actual solder pallet to conform to the printed circuit board design utilized by a particular application. The resulting solder pallet can be used in a wave soldering process to selectively affix solder to specified areas of a circuit board having electronic components.

Some significant potential benefits include higher temperature performance (270 degrees C. Tg vs. competitors at ˜170-190 degrees C.), ease of machining, long-term wear and durability under a combination of high temperature exposure and aggressive chemicals. In addition, there is no glass exposure due to wear, which is a major problem with competitive materials. Furthermore, the product is molded to the desired thickness/flatness spec avoiding any need to sand or grind down the plaque to the desired thickness/flatness specification.

The resulting plaque can thus be adapted for use as a solder pallet or other device that is a high temperature, fiber-reinforced, phenolic molding compound-single stage, comprising epoxy laminates that are compression molded into 25″×25″ plaques that will typically run 3 mm-12 mm thick, with 6 mm probably being the most popular. At least two grades can be provided, standard and ESD safe (having a resistivity of about 10ˆ-5 thru 10ˆ-9 ohms/cm). Colors include black along with others. The resulting plaques of at least one embodiment show excellent machinability, chemical resistance, and excellent appearance, with a flex strength of about 25 ksi, an HDT>570 degrees F., Tg˜290 C., warp of about ±0.015″, and a thickness tolerance of about ±0.005″, for example.

The invention has been described hereinabove using specific examples and embodiments; however, it will be understood by those skilled in the art that various alternatives may be used and equivalents may be substituted for elements and/or steps described herein, without deviating from the scope of the invention. Modifications may be necessary to adapt the invention to a particular situation or to particular needs without departing from the scope of the invention. It is intended that the invention not be limited to the particular implementations and embodiments described herein, but that the claims be given their broadest interpretation to cover all embodiments, literal or equivalent, disclosed or not, covered thereby

What is claimed is:

1. A flat plaque for use in a soldering process, said plaque comprising:
a thermoset phenolic resin; and
a re-enforcing fiber distributed throughout said plaque, wherein
said composition has been formed into said flat plaque at a desired thickness.

2. The plaque of claim 1, wherein said plaque has a glass transition temperature of more than 190 degrees Celsius.

3. The plaque of claim 2, wherein said glass transition temperature is about 270 degrees Celsius or more.

4. The plaque of claim 1, further comprising one or more metallo-silicates.

5. The plaque of claim 1, further comprising a conducting or semi-conducting material also distributed throughout said plaque, wherein said plaque is at least semi-conducting for discharging static electricity.

6. A solder pallet for use in a soldering process, said pallet comprising:
at least a portion of said plaque of claim 5, and
means for holding a circuit board on said solder pallet.

7. The plaque of claim 1, wherein said desired thickness is of a substantially constant thickness within the range of about 3 mm to about 12 mm.

8. A solder pallet comprising:
at least a portion of said plaque of claim 1, and
means for holding a circuit board on said solder pallet.

9. A plaque for use in making a solder pallet, said plaque comprising:
a thermoset phenolic resin;
a glass re-enforcing fiber distributed throughout said plaque; and
a conducting or semi-conducting material distributed throughout said plaque, wherein
said plaque has a glass transition temperature of more than 190 degrees Celsius; and wherein
said plaque is at least semi-conducting for discharging static electricity that may be present during use of said solder pallet.

10. The plaque of claim 9, wherein said plaque is of a substantially constant thickness within the range of about 3 mm to about 12 mm.

11. A solder pallet comprising:
at least a portion of said plaque of claim 10, and
means for holding a circuit board on said solder pallet.

12. The plaque of claim 9, further comprising an internal lubricant.

13. A solder pallet comprising:
at least a portion of said plaque of claim 9 having at least one hole formed therethrough, and
means for holding a circuit board on said solder pallet, wherein
said at least one hole is provided for providing contact between said circuit board or a component mounted on the circuit board and molten solder.

14. A method of manufacturing a plaque for use in a soldering process, said method comprising the steps of:
providing a composition including a thermoset phenolic resin and a plurality of re-enforcing fibers;
molding said plaque in a mold by providing heat and pressure to said composition to form a solid plaque of a desired thickness.

15. The method of claim 14, wherein said plaque is molded to a substantially constant thickness within the range of about 3 mm to about 12 mm.

16. The method of claim 14, wherein said plaque has a glass transition temperature of more than 170 degrees Celsius.

17. The method of claim 16, wherein said glass transition temperature is about 270 degrees Celsius or more

18. The method of claim 14, wherein said providing said composition further comprises the steps of:
mixing said resin and said re-enforcing fibers together to form a precursor composition; and
forming a portion of said precursor composition into one or more preforms.

19. The method of claim 18, wherein a pre-heating step of preheating said one or more preforms precedes said molding step.

20. The method of claim 19, further comprising the step of forming said plaque into at least one solder pallet.

21. The method of claim 19, further comprising the step of transferring said plaque to a flatness device for cooling said plaque at an elevated temperature to maintain a flatness of said plaque.

22. The method of claim 21, further comprising the step of forming said plaque into at least one solder pallet.

23. The method of claim 18, further comprising the step of transferring said plaque to a flatness device for cooling said plaque at an elevated temperature to maintain a flatness of said plaque.

24. The method of claim 14, further comprising the step of transferring said plaque to a flatness device for cooling said plaque at an elevated temperature to maintain a flatness of said plaque.

25. The method of claim 14, wherein a pre-heating said composition step precedes said molding step.

26. The method of claim 14, further comprising the step of forming said plaque into a solder pallet.

27. A method of manufacturing a plaque for use in a soldering process, said method comprising the steps of:
providing a precursor composition including the steps of:
providing a thermoset phenolic resin,
providing re-enforcing fibers, and
forming said resin and fibers into said precursor composition;
forming one or more preforms by putting a portion of said precursor composition under pressure to form said preforms;
pre-heating said one or more preforms;
molding said pre-heated one or more preforms in a mold by providing heat and pressure to said one or more preforms to form a molded plaque; and
maintaining a flatness of said plaque by cooling said molded plaque against smooth surfaces at an elevated temperature, thereby forming said plaque.

28. The method of claim 27, wherein said step of providing a precursor composition further includes the step of providing a conducting or semi-conducting material to be included in said forming step so that said plaque can discharge static electricity.

29. The method of claim 28, further comprising the step of forming said plaque into a solder pallet, said forming including the steps of:
machining said plaque into at least one solder pallet;
providing a means of holding a circuit board to said solder pallet; and
forming at least one hole in said solder pallet for providing access of at least a portion said circuit board to a solder bath during use of said solder pallet in a soldering process.

30. The method of claim 27, further comprising the step of forming said plaque into a solder pallet, said forming including the steps of:
machining said plaque into at least one solder pallet;
providing a means of holding a circuit board to said solder pallet; and
forming at least one hole in said solder pallet for providing access of at least a portion said circuit board to a solder bath during use of said solder pallet in a soldering process.
